(19) United States
(12) Patent Application Publication
(10) Pub. No.: US 2024/0352310 A1
(43) Pub. Date: Oct. 24, 2024

(54) AMORPHOUS TRIBOLUMINESCENT MATERIAL, METHOD FOR PRODUCING THE SAME, METHOD FOR GENERATING LIGHT EMISSION IN AMORPHOUS TRIBOLUMINESCENT LAYER, AND MECHANORESPONSIVE SENSOR

(71) Applicant: Okinawa Institute of Science and Technology School Corporation, Kunigami-gun, Okinawa (JP)

(72) Inventors: Ayumu KARIMATA, Kunigami-gun, Okinawa (JP); Julia KHUSNUTDINOVA, Kunigami-gun, Okinawa (JP)

(21) Appl. No.: 18/688,184

(22) PCT Filed: Aug. 29, 2022
(86) PCT No.: PCT/JP2022/032429

§ 371 Date: Feb. 29, 2024

(30) Foreign Application Priority Data
Sep. 2, 2021 (JP) 2021-143024

(51) Int. Cl. C09K 11/06; C09K 11/02

(52) U.S. Cl. CPC C09K 11/06; C09K 11/02; C09K 2211/1011

(57) ABSTRACT

Triboluminescent materials that produce light emission in response to mechanical action attract significant interest due to their wide range of potential utilization for mechanoresponsive sensors, light emitting devices and stimuli-induced glowing fibers, dyes, particles, paste, and films, etc. Here, we would like to disclose a general method of generating triboluminescent polymer materials blended with wide range of luminophores that emit light in response to mechanical action emitting light in a wide range of spectrum. The light generation is achieved via a non-destructive method even in the absence of direct contact with the polymer (e.g. through the layer of another polymer). Biocompatible luminophores can be easily utilized. Light emission is also observed under dry air.

### DESCRIPTION

### Technical Field

The present invention relates to an amorphous triboluminescent material that emits light in response to mechanical action, a method for producing the same and a mechanoresponsive sensor using the same. More specifically, the present invention relates to a stimuli-induced glowing material such as stimuli-induced glowing fibers, dyes, particles, paste, and films.

### Background Art

Triboluminescent, or mechanoluminescent materials that produce light emission in response to mechanical action (fracture, crushing, rubbing, etc) are promising materials for utilization in mechanoresponsive sensors, light emitting devices via direct conversion of mechanical action to light, etc (for example, NPL 1)^{[1]}. While many solid crystalline materials are known to be triboluminescent, some potential drawbacks include necessity of the presence of crystalline phase. Widely used europium-containing triboluminescent solid materials or polymers also have potential limitations due to the usage of expensive europium-containing compounds. Limited number of biocompatible triboluminescent materials also limit their utilization in healthcare and health monitoring devices, stimuli-sensors in biology, fashion items.

Although examples of photoluminescent compounds that show triboluminescence in polymer films are known, nature of observed phenomenon is not clear and the presence of crystalline phase is not always confirmed. Several examples are reported for Eu-containing polymer films (for example, NPL 2)^{[2]}, however, no studies are reported that could confirm the absence or presence of microcrystalline phase. Some semiconducting particles such as metal doped zinc sulfide or rare-earth doped ceramics showing TL in polymers have been developed, however, these systems require trapped electron in the band structure to cause TL. Other examples of triboluminescence in polymers involve polymer fracture or the use of specialized equipment to observe inert gas plasma generation via triboelectrification (NPL 3)^{[3]}. The previous study of Cu complex-containing polymer films reported in the literature shows that the presence of microcrystalline phase is required to observe triboluminescence (NPL 4)^{[4]}, and no triboluminescence is seen in amorphous state.

### CITATION LIST

### Non Patent Literature

NPL 1: J.-C. G. Bunzli, K.-L. Wong, Journal of Rare Earths 2018, 36, 1-41.

NPL 2: R. S. Fontenot, W. A. Hollerman, K. N. Bhat, M. D. Aggarwal, B. G. Penn, Polymer Journal 2014, 46, 111-116.

NPL 3: K. Nakayama, R. A. Nevshupa, Journal of Tribology 2003, 125, 780-787.

NPL 4: A. Incel, C. Varlikli, C. D. McMillen, M. M. Demir, The Journal of Physical Chemistry C 2017, 121, 11709-11716.

### SUMMARY OF INVENTION

### Technical Problem

As described above, conventionally reported triboluminescent materials are limited to those using a specific luminophore, those having a crystal structure, and those in a specific electronic state. The object of the invention is to provide a new triboluminescent material that can apply a wide range of luminophores blended in varied polymers.

In this situation, the present inventors have performed investigations with the aim of developing a new amorphous triboluminescent material.

### Solution to Problem

The present application includes the following inventions:

[1] An amorphous triboluminescent material comprising a luminophore and a polymer.

In the present application, the term “amorphous triboluminescent material” is defined as a material comprising an amorphous layer that generates emission of light in response to mechanical stimulus without excitation by light such as ultraviolet, infrared ray and without application of electric current. The amorphous triboluminescent material may be in the form of films, fibers, particles, pastes, slurries, dyes, etc. The term “amorphous” referred herein means a state formed by blending the luminophore molecules and the polymer molecules without forming crystals having a regular spatial arrangement. In the present application, amorphous is confirmed by powder X-ray diffraction method and emission microscopy imaging. The mechanical stimuli includes mechanical stress, strain and deformation, and they are derived from a mechanical action such as compression, tension, tensile strength, impact, sharing, bending, abrasion, torsion, scratching, crushing, rubbing, grinding and ultrasound. The amorphous triboluminescent materials do not need irradiation of excitation light, such as UV light, from the outside to emit light

The term “luminophore” in the present application is defined as a substance that generates emission of light including fluorescence, phosphorescence, long persistent emission, caused by irradiation of light. The light emission generated in the amorphous triboluminescent material is derived from the luminophore. In a preferred embodiment of the present application, the luminophore does not contain a polymer structure. In another preferred embodiment of the present application, the molecular weight of the luminophore is less than 1000.

The term “polymer” in the present application is defined as a compound having a unit recurring at least three times, and the term “polymer structure” in the present application is defined as a structure having a unit recurring at least three times. The “unit recurring” referred to here is a structure derived from a monomer as a synthetic raw material for the polymer.

In one embodiment of the present application, the amorphous triboluminescent material comprises a mixed layer of a luminophore and a polymer. In another embodiment of the present application, the amorphous triboluminescent material comprises a polymer layer containing an amorphous polymer and a light-emitting body impregnated in the polymer layer. In this case, preferably, a luminophore is impregnated in the vicinity of the surface of the polymer layer to form a light-emitting region.

[2] The amorphous triboluminescent material according to [1], wherein the luminophore is free from Cu.

The luminophore may be composed of two or more atoms selected from the group consisting of a hydrogen atom, a carbon atom, a nitrogen atom, an oxygen atom, a sulfur atom and a halogen atom. The luminophore may contain a metal atom selected from Ir, Ru and Eu.

[3] The amorphous triboluminescent material according to [1] or [2], wherein the luminophore is not attached to the polymer covalently.

[4] The amorphous triboluminescent material according to [1] or [2], wherein the luminophore have a condensed polycyclic structure in which three or more rings are condensed.

[5] The amorphous triboluminescent material according to any one of [1] to [4], wherein at least one of the luminophore and the polymer is biocompatible.

Examples of the luminophore having biocompatibility include a luminophore having a ring skeleton common to a biological material.

[6] The amorphous triboluminescent material according to any one of [1] to [5], wherein the polymer is an amorphous polymer.

[7] The amorphous triboluminescent material according to any one of [1] to [5], wherein

the material comprises an amorphous triboluminescent layer containing the luminophore and the polymer, and a luminophore-free layer containing a polymer and not containing a luminophore, and

the polymer of the amorphous triboluminescent layer is an amorphous polymer.

[8] The amorphous triboluminescent material according to [7], wherein the luminophore-free layer is laminated on the amorphous triboluminescent layer.

[9] The amorphous triboluminescent material according to [7] or [8], wherein the polymer of the amorphous triboluminescent layer and the polymer of the luminophore-free layer are different kind of polymers.

[10] The amorphous triboluminescent material according to any one on [7] to [9], wherein the polymer of the luminophore-free layer is a crystalline polymer.

[11] The amorphous triboluminescent material according to any one of [7] to [10], wherein the amorphous triboluminescent layer is entirely covered with the luminophore-free layer.

[12] The amorphous triboluminescent material according to any one of [7] to [10], wherein a part of the amorphous triboluminescent layer is covered with the luminophore-free layer.

[13] A method for generating light emission in the amorphous triboluminescent material of [8] comprising applying mechanical action to the surface of the luminophore-free layer on the opposite side of the amorphous triboluminescent layer to generate light emission in the amorphous triboluminescent layer.

[14] A method for generating light emission in an amorphous triboluminescent material comprising:

1) arranging a luminophore-free film comprising a polymer and not comprising a luminophore on an amorphous triboluminescent material comprising a luminophore and a polymer, and

2) applying mechanical action to the surface of the luminophore-free film on the opposite side of the amorphous triboluminescent material to generate light emission in the amorphous triboluminescent material.

[15] A method for producing an amorphous triboluminescent film comprising: coating a solution of a luminophore and a polymer and drying the coated solution, or spreading a solid mixture of a luminophore and a polymer into a film.

The solid mixture of a luminophore and a polymer may be free from a solvent. In the present application, painting solutions, solutions containing solids, suspensions, dispersions, pastes, slurries and colloidal solutions can be used to produce an amorphous triboluminescent film.

[16] A method for producing an amorphous triboluminescent material comprising: impregnating a polymer film containing an amorphous polymer with a luminophorc.

[17] A mechanoresponsive sensor, fiber, film or dye comprising the amorphous triboluminescent material of any one of [1] to [12].

In the present application, the term “mechanoresponsive sensor” is defined as a device that detects mechanical stimulus or mechanical damage and responds to it.

### BRIEF DESCRIPTION OF DRAWINGS

FIG. 1 is fluorescence microscopy images of PMMA films containing 2 or 3 wt % of (a) Py (Iₑₓ=380, Iₑₘ=447), (b) DPA (Iₑₓ=405, Iₑₘ=522), (c) TPE (Iₑₓ=380, Iₑₘ=447), (d) Coumarin 153 (Iₑₓ=405, Iₑₘ=522), (e) VB2-B (Iₑₓ=488, Iₑₘ=522), (f) Cu(dmp)Xantp (Iₑₓ=405, Iₑₘ=522), (g) Ir(ppy)₃ (Iₑₓ=405, Iₑₘ=522), (h) Ru(phen)₃ (Iₑₓ=405, Iₑₘ=617), and (i) Eu(acac)₃phen (Iₑₓ=405, Iₑₘ=617). Iₑₓ is excitation wavelength (nm), and Iₑₘ is monitored emission wavelength.

FIG. 2 is PXRD patterns of PMMA films including 2 or 3 wt % of luminophores.

FIG. 3 is PXRD patterns of PMMA films containing 5, 10, or 15 wt % of luminophores.

FIG. 4 is a PXRD pattern of PMMA film without luminophore.

FIG. 5 is normalized TL spectra of luminophores (1 wt %) blended in PMMA under Ar.

FIG. 6 is PL spectra of luminophores (1 wt %) in PMMA under N₂ gas flow.

FIG. 7 is images of TL of PMMA films containing 10 wt % of (a) Py (b) DPA (c) TPE (d) Coumarin 153 (e) VB2-B (f) Cu(dmp)Xantp, and (g) 3 wt % of Ir(ppy)₃ (h) 5 wt % of Ru(phen)₃, and (i) 15 wt % of Eu(acac)₃phen. The films were rubbed with a glass rod under Ar.

FIG. 8 is TL spectra of (a) Py (2 wt %) (b) DPA (2 wt %), (c) TPE (2 wt %), (d) Coumarin 153 (3 wt %), (e) VB₂-B (2 wt %) in PMMA in different gas, and (f) Cu(dmp)Xantp (3 wt %).

FIG. 9 is TL spectra of (g) Ir(ppy)₃ (2 wt %), (h) Ru(phen)₃ (2 wt %), and (i) Eu(acac)₃phen (3 wt %) in PMMA in different gas.

FIG. 10 is normalized TL spectra of (a) PMMA (b) PS (c) PCL (d) PBAC and (e) PVC under N₂, He, and Ar atmosphere.

FIG. 11 is TL spectra of (a) Py (2 wt %) (b) Py (10 wt %) (c) DPA (2 wt %), (d) TPE (2 wt %), (e) Coumarin 153 (3 wt %), (f) VB₂-B (2 wt %) (g) Cu(dmp)Xantp (3 wt %), (h) Ir(ppy)₃ (2 wt %), (i) Ru(phen)₃ (2 wt %), and (j) Eu(acac)₃phen (3 wt %) in various polymers obtained by rubbing the surface with glass rod under Ar.

FIG. 12 is full range TL spectra of (a) Py (2 wt %) (b) Py (10 wt %) (c) DPA (2 wt %), (d) TPE (2 wt %), (e) Coumarin 153 (3 wt %), (f) VB₂-B (2 wt %) (g) Cu(dmp)Xantp (3 wt %), (h) Ir(ppy)₃ (2 wt %), (i) Ru(phen)₃ (2 wt %), and (j) Eu(acac)₃ phen (3 wt %) in various polymers obtained by rubbing the surface with glass rod under Ar.

FIG. 13 is an illustration of TL of luminophores blended in polymer generated by rubbing the cover film.

FIG. 14 is normalized TL spectra of 1 wt % of luminophores in (a) PMMA and (b) PS under dry air. The PMMA and PS containing luminophores were covered with PVC film (thickness: ca. 20 μm) and rubbed with glass rod over the PVC cover film.

FIG. 15 is images of TL of 2 wt % of Ir(ppy)₃ in PS under flow of dry air in a glove (thickness: ca. 20 μm) and rubbed over the PVC film using a rubber rod.

FIG. 16 is images of TL of PS films containing 1 wt % of (a) Py (b) DPA (c) TPE (d) Coumarin 153 (c) VB2-B (f) Cu(dmp)Xantp (g) Ir(ppy)₃ (h) Eu(acac)₃phen. The PS films were covered with PVC films (thickness: ca. 20 μm) and were stroked over the PVC using a silicone rubber under Ar. Exposure time of camera is 5 seconds. The PS and PVC are hold by a finger on window of glove box.

FIG. 17 is TL spectra of PBAC films containing 3 wt % of (a) DPA and (b) Cu(dmp)xantp under humid air at 23° C., (Relative humidity: 34%). The films were rubbed by a glass tube containing an optic fiber probe.

FIG. 18 is photographs of TL of PBAC films containing 10 wt % of (a) DPA and (b) Cu(dmp)xantp under humid air at 24° C., (Relative humidity: 40%). The films were rubbed by a silicone rubber rod on a glass Petri dish. The exposure time of the camera is 5 seconds.

FIG. 19 is photograph of a painting drawn by permanent fluorescent markers on PS film on a glass Petri dish fixed by a Scotch tape, which was used for TL performance experiments. (b) The painting under UV lamp. (c) TL of the painting in a glove box generated by rubbing the PVC covering film using a silicone rubber rod. (The exposure time of the camera is 5 seconds) All of color components of fluorescent marker generate emission. Humidity is zero, confirmed by a sensor in the glovebox.

FIG. 20 is Illustration of generation of TL of the polymer containing a luminophore in a vacuumed glass flask. (a) Photograph of the glass flask, in which a PMMA film is placed, before rubbing. Photographs of TL of PMMA films containing 10 wt % of (b) DPA (c) Cu(dmp)xantp under vacuum in a round-bottom flask, which was generated by rubbing the bottom of the flask with a rubber glove. (d) The flask in a dark without rubbing. Exposure time of the camera is 5 seconds. It is humid air.

### DESCRIPTION OF EMBODIMENTS

The contents of the invention will be described in detail below. The constitutional elements may be described below with reference to representative embodiments and specific examples of the invention, but the invention is not limited to the embodiments and the examples. In the present specification, a numerical range expressed by “from X to Y” means a range including the numerals X and Y as the lower limit and the upper limit, respectively.

### Amorphous Triboluminescent Material

The amorphous triboluminescent material of the invention comprises a luminophore and a polymer. In one embodiment of the invention, the luminophore is not attached to the polymer covalently. In preferred embodiment of the invention, the amorphous triboluminescent material comprises at least one amorphous triboluminescent layer. The amorphous triboluminescent layer is an amorphous layer comprising the luminophore and an amorphous polymer and generating light emission in response to a mechanical action to the amorphous triboluminescent material.

Hereinafter, each component comprised in the amorphous triboluminescent material of the invention will be described.

### Luminophore

The luminophore may be a fluorescent material, a delayed fluorescent material, a phosphorescent material, or a long persistent luminescent material using semiconducting particles or metal ions. In one embodiment of the invention, the luminophore is an organic compound containing no metal element. For example, the luminophore is composed of two or more atoms selected from the group consisting of a hydrogen atom, a carbon atom, a nitrogen atom, an oxygen atom, a sulfur atom and a halogen atom. A luminophore free from a metal element is easily dispersed in a polymer. In one embodiment of the invention, the luminophore is free from Cu. In one embodiment of the invention, the luminophore contains a metal selected from Ir, Ru and Eu. In one embodiment of the invention, the luminophore is free from an N-heterocyclic carbene ligand and a pyridinophane ligand.

Examples of the luminophore include an aromatic compound, a heteroaromatic compound and an organometallic complex. The term “aromatic compound” referred herein means a compound containing at least one aromatic ring. The term “hetcroaromatic compound” referred herein means a compound containing at least one hetcroaromatic ring. The aromatic ring and the heteroaromatic ring may be a monocyclic ring and may be a fused ring having a condensed polycyclic structure. Examples of the heteroatom constituting the heteroaromatic ring include nitrogen atom, oxygen atom, and sulfur atom.

Examples of the aromatic compound as the luminophore include a condensed polycyclic aromatic compound having a polycyclic aromatic ring in which two or more benzene rings are condensed, and a compound having a structure in which two or more aromatic rings (for example, a benzene ring) are linked by a cat-conjugated linking group. At least one hydrogen atom each of the aromatic ring and the π-conjugated linking group may be substituted with a substituent. Specific examples of the ring skeleton of the condensed polycyclic aromatic compound include an anthracene ring and a pyrene ring. The π-conjugated linking group is a linking group that forms a π-conjugated system with a double bond of the aromatic rings, and examples thereof include an ethenylene group, a 1,3-butadiene-1,4-diyl group, and a linking group having a polyene structure.

Examples of the substituent for the aromatic ring and the π-conjugated linking group include an alkyl group (preferably having 1 to 50 carbon atoms), an alkenyl group (preferably having 1 to 50 carbon atoms), an alkynyl group (preferably having 1 to 50 carbon atoms), an alkoxy group (preferably having 1 to 50 carbon atoms), a nitro group, a cyano group, a halogen atom, a hydroxy group, a thiol group, an acyl group (preferably having 1 to 50 carbon atoms), a silyl group (preferably having 1 to 50 carbon atoms), an amino group, an aldehyde group, an isocyanate group, a triazolyl group, an aryl group (preferably having 6 to 50 carbon atoms), a heterocycloalkyl group (preferably having 3 to 50 carbon atoms), and a heteroaryl group (preferably having 3 to 50 carbon atoms). These exemplified groups may be further substituted. Such further substituted groups include, for example, an aralkyl group, a haloalkyl group, and an alkoxysilyl group. The substituents for the aromatic ring and the π-conjugated linking group may have a carboxyl bond, a carboxyamide bond, an ester bond, an amide bond, a sulfide bond, a disulfide bond and the like.

Preferred examples of the aromatic compound as the luminophore include the compounds having a structure represented by any of the following formulae. At least one hydrogen atom contained in the following structure may be substituted with a substituent. For preferred ranges of the substituent and specific examples thereof, the descriptions for the substituent for the aromatic ring and the π-conjugated linking group above may be referenced.

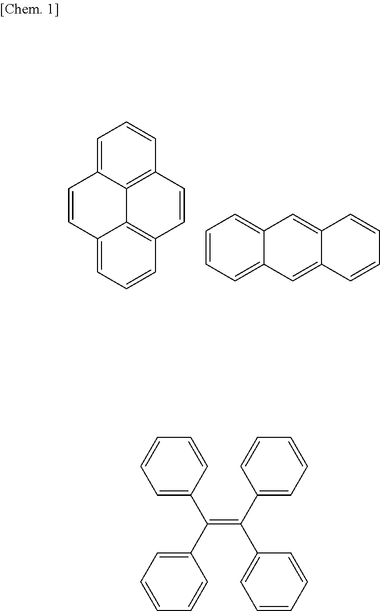

Preferred examples of the heteroaromatic compound as the luminophore include the compounds having a structure represented by any of the following formulae. At least one hydrogen atom contained in the following structure may be substituted with a substituent. For preferred ranges of the substituent and specific examples thereof, the descriptions for the substituent for the aromatic ring and the π-conjugated linking group above may be referenced.

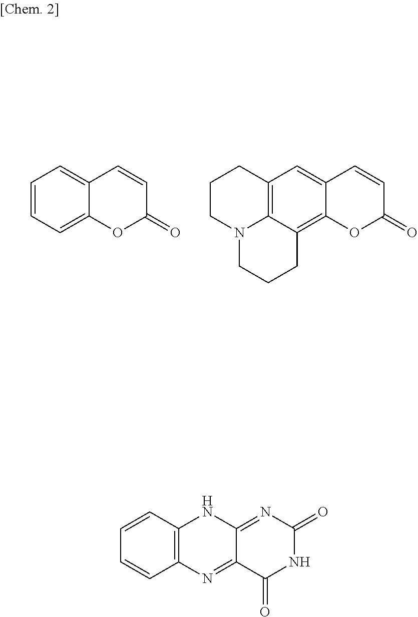

More preferred examples of the heteroaromatic compound as the luminophore include a compound represented by the following formula (1) or (2).

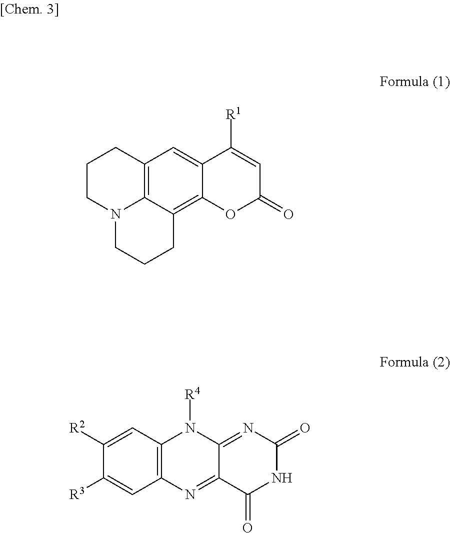

In the formula (1), R¹ represents a fluoroalkyl group. In the formula (2), R² and R³ each independently represent an alkyl group, R⁴ represents an alkyl group substituted with an alkylcarbonyloxy group. R² and R³ may be the same as or different from each other. The compounds represented by the formula (2) have high biocompatibility as they have the ring structure of vitamin B2.

In the formula (1), the fluoroalkyl group for R¹ may be a perfluoroalkyl group in which all hydrogen atoms of the alkyl group are substituted with a fluorine atom, or a partially fluoroalkyl group in which at least one but not all of the hydrogen atoms of the alkyl group are substituted with a fluorine atom. The fluoroalkyl group may be linear, branched or cyclic. The fluoroalkyl group preferably has from 1 to 20 carbon atoms, more preferably from 1 to 10 carbon atoms, and further preferably from 1 to 5 carbon atoms. Specific examples of the fluoroalkyl group include a perfluoromethyl group (a trifluoromethyl group), a perfluoroethyl group and a perfluoropropyl group.

In the formula (2), The alkyl group for R² and R³ may be linear, branched or cyclic. The alkyl group preferably has from 1 to 20 carbon atoms, more preferably from 1 to 10 carbon atoms and further preferably from 1 to 5 carbon atoms. Specific examples of the alkyl group include a methyl group (Me), an ethyl group, a n-propyl group (n-Pr), an isopropyl group (i-Pr), a n-butyl group, an isobutyl group, a sec-butyl group and a tert-butyl group (t-Bu).

The alkyl group substituted with the alkylcarbonyloxy group for R⁴ preferably has a structure represented by the following formula.

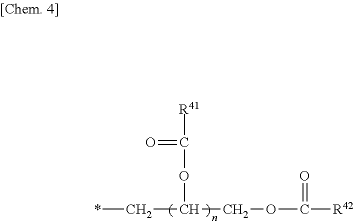

In the formula, R⁴¹ and R⁴² each independently represent an alkyl group, n represents an integer of 0 or more, and * represents a bond position to the nitrogen atom. R⁴¹ and R⁴² may be the same as or different from each other. When n is 2 or more, the two or more R⁴¹s may be the same as or different from each other. For descriptions for the alkyl group, the preferred ranges thereof, and specific examples thereof, the descriptions for the alkyl group for R² and R³ above may be referenced. n is preferably from 0 to 8, more preferably from 1 to 6, and further preferably from 2 to 4.

Examples of the organometallic complex as the luminophore include an complex having central metal selected from the group consisting of Cu, Ir, Ru and Eu, and examples of a ligand thereof include a ligand containing a heteroaromatic ring such as a pyridine ring or a pyrrole ring, a ligand having a phosphine structure and a diketone ligand. The heteroaromatic ring in the ligand may be a monocyclic ring, or may be a fused ring in which one or more heteroaromatic rings are condensed with one or more aromatic rings or heterocycles. At least one hydrogen atom of the heteroaromatic ring may be substituted with a substituent.

Preferred examples of the ligand include the structure represented by any of the following formulae.

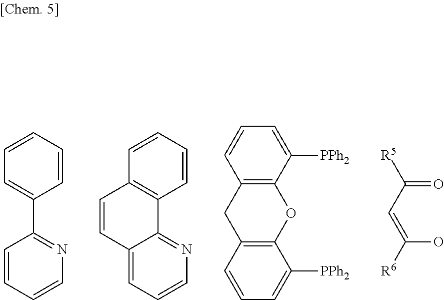

In the above formula, Ph represents a phenyl group. R⁵ and R⁶ each independently represent an alkyl group having 1 to 10 carbon atoms. R⁵ and R⁶ may be the same as or different from each other. For descriptions for the alkyl groups and the preferred ranges and specific examples thereof, the descriptions for the alkyl groups for R² and R³ above may be referenced. At least one hydrogen atom contained in the above structure may be substituted with a substituent. For preferred ranges of the substituent and specific examples thereof, the descriptions for the substituent for the aromatic ring and the π-conjugated linking group above may be referenced.

Specific examples of the luminophore are shown below. However, the luminophore capable of being used in the invention is not construed as being limited to the specific examples.

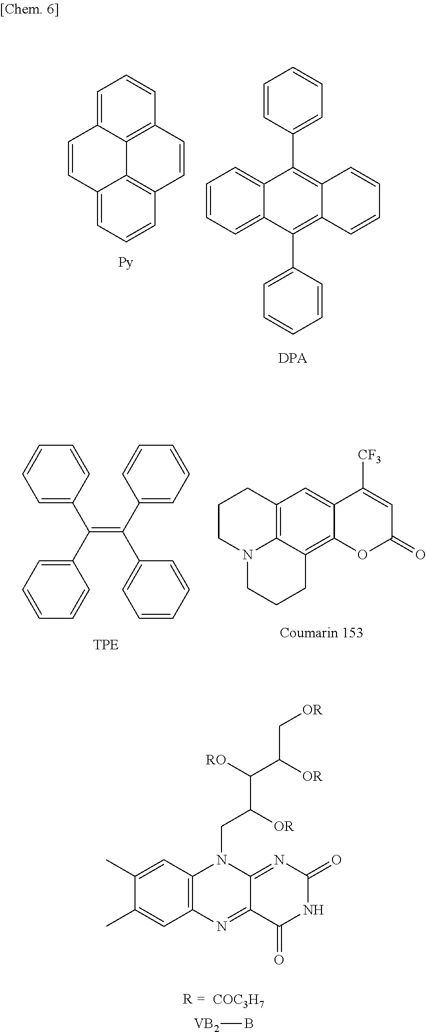

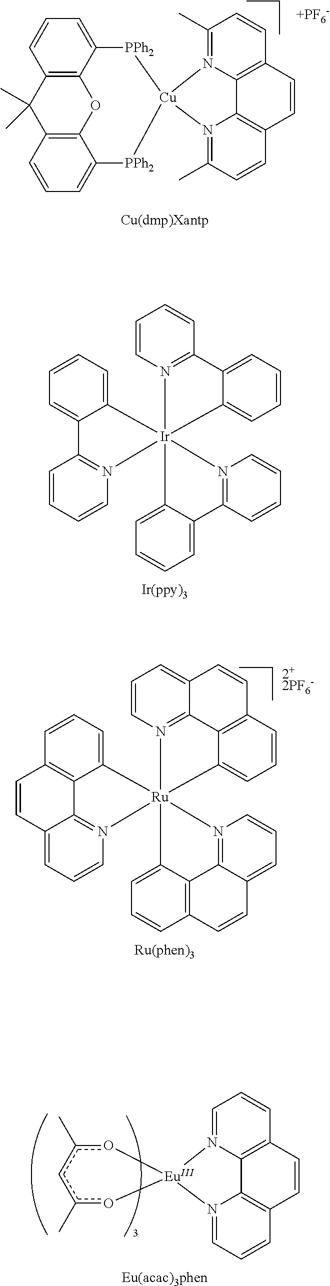

The luminophore contained in the amorphous triboluminescent material may be one kind or two or more kinds.

### Polymer

The polymer has the function as a matrix material for the luminophore. Further, in the amorphous triboluminescent material, the polymer of the amorphous triboluminescent layer is an amorphous polymer.

Examples of the polymer include a polyacrylate, a polymethacrylate, a polystyrene, a poly (ε-caprolactone), a polycarbonate (a poly (bisphenol A) carbonate), a polyvinyl chloride, a polyurethane, a polyester, a polyamide, a polylactone, a polyalkyleneoxide, a polysiloxane, a polydimethylsiloxane, a polylactide, a polyolefin, a polyisobutylene, a polyamideimide, a polybutadiene, an epoxy resin, a polyacetylene, and a vinyl polymer. An amorphous polymer selected from these polymers may be used in the triboluminescent amorphous layer. Preferred examples of the amorphous polymer include polyacrylate, polymethacrylate, polystyrene, poly (ε-caprolactone), polycarbonate (poly (bisphenol A) carbonate), and polyvinyl chloride. Among these, the poly (ε-caprolactone) has high biocompatibility. The polyacrylate is preferably a polyalkylacrylate, and the polymethacrylate is preferably a polyalkylmethacrylate. The number of carbon atoms of the alkyl group of the polyalkyl acrylate and the polyalkyl methacrylate is preferably from 1 to 40, more preferably from 1 to 20, and further preferably from 1 to 6. The molecular weight of the polymer is not particularly limited and may be selected from, for example, the range of 1000 to 300000, more preferably 5000 to 50000. The polymer contained in the amorphous triboluminescent material may be one kind or two or more kinds.

The polymer used in the invention may or may not have a photoluminescent moicty in the repeating unit of the polymer. The photoluminescent moicty may show fluorescence, phosphorescence, thermally activated delayed fluorescence, or long-persistent luminescence. In one embodiment of the invention, the polymer in the amorphous triboluminescent material does not have a photoluminescent moicty.

### Amount Ratio of Luminophore to Polymer

The amount of the luminophore in the amorphous triboluminescent material is preferably 0.001% by weight or more, more preferably 0.01% by weight or more, further preferably 0.1% by weight or more, preferably 30% by weight or less, more preferably 10% by weight or less, further preferably 5% by weight by weight or less, cach based on the total weight of the polymer.

### Other Components of Amorphous Triboluminescent Material

The amorphous triboluminescent material of the invention may consist of the luminophore and the polymer only or may further comprises other components.

### Amorphous Triboluminescent Material Layer

The amorphous triboluminescent material of the invention may have a single-layer structure with only one layer (the amorphous triboluminescent layer) containing the luminophore and the amorphous polymer, or may have a multi-layer structure with two or more layers. In the case where the amorphous triboluminescent material has a multi-layer structure, all layers of the multi-layer structure may be an amorphous triboluminescent layer containing the luminophore and the amorphous polymer, or at least one layer is an amorphous triboluminescent layer containing the luminophore and the amorphous polymer and at least one layer is a luminophore-free layer containing a polymer and not containing a luminophore. In preferred embodiment of the invention, the luminophore-free layer is laminated on the amorphous triboluminescent layer. In more preferred embodiment of the invention, the luminophore-free layer (first luminophore-free layer), the amorphous triboluminescent layer, and the luminophore-free layer (second luminophore-free layer) are laminated in this order. In another preferred embodiment, the amorphous triboluminescent layer is entirely covered with the luminophore-free layer.

In the case where the amorphous triboluminescent material comprises the amorphous triboluminescent layer and the luminophore-free layer, the polymer contained in the amorphous triboluminescent layer and the polymer contained in the luminophore-free layer may be the same as or different from each other, but are preferably different. The polymer contained in the luminophore-free layer may be a crystalline polymer or an amorphous polymer. Examples of the crystalline polymer include a polyethylene, polypropylene (PE), a polyamide (PA), a polyacetal (POM), a polyethylene terephthalate (PET), a polybutylene terephthalate (PBT), a polyphenylene sulfide (PPS), a polyether ether ketone (PEEK), a liquid crystal polymer, and a polytetrafluorocthylene (PTFE). For examples of the amorphous polymer, the descriptions in the paragraph “Polymer” above may be referenced.

The thickness of the amorphous triboluminescent material may be appropriately determined depending on the application, and may be selected from the range of, for example, from 0.1 to 100000 μm, preferably from 1 to 10000 μm, for example from 1 to 1000 μm, or from 10 to 200 μm. In the case where the amorphous triboluminescent material has a multi-layer structure, the thickness of the amorphous triboluminescent layer is preferably from 0.1 to 1000 μm, more preferably from 0.1 to 100 μm, for example from 1 to 10 μm. The thickness of the luminophore-free layer is preferably from 0.1 to 10000 μm, more preferably from 1 to 1000 μm, for example from 5 to 50 μm.

### Method for Generating Light Emission in Amorphous Triboluminescent Material

The method of the invention is a method for generating light emission in the amorphous triboluminescent material in which the luminophore-free layer is laminated on the amorphous triboluminescent layer, and comprises:

applying mechanical action to the surface of the luminophore-free layer on the opposite side of the amorphous triboluminescent layer to generate light emission in the amorphous triboluminescent layer.

Another method the invention is a method for generating light emission in the amorphous triboluminescent material, and comprises:

1) arranging a luminophore-free film comprising a polymer and not comprising a luminophore on an amorphous triboluminescent material comprising a luminophore and a polymer, and

2) applying mechanical action to the surface of the luminophore-free film on the opposite side of the amorphous triboluminescent material to generate light emission in the amorphous triboluminescent material.

For descriptions for the amorphous triboluminescent material, the amorphous triboluminescent layer and the luminophore-free layer, the corresponding descriptions for the amorphous triboluminescent material above may be referenced.

Examples of a mechanical action capable of being used in these methods include compression, tension, tensile strength, impact, sharing, bending, abrasion, torsion, scratching, crushing, rubbing, grinding and ultrasound.

In these methods, it is possible to generate light emission in the amorphous triboluminescent layer without directly applying a mechanical action to the amorphous triboluminescent layer (with indirectly applying a mechanical action to the amorphous triboluminescent layer). Therefore, damage to the amorphous triboluminescent layer due to the mechanical action is suppressed.

### Method for Producing Amorphous Triboluminescent Film

The amorphous triboluminescent material is preferably in the form of a film (amorphous triboluminescent film).

One method of the invention is a method of producing an amorphous triboluminescent film, and comprises coating a solution of a luminophore and a polymer and drying the coated solution.

For descriptions of the amorphous triboluminescent film, the luminophore, the polymer, and ratio of the amount of the luminophore to the polymer, the corresponding descriptions in the descriptions for the amorphous triboluminescent film above may be refenced.

Examples of the solvent capable of being used for the solution include aromatics such as benzene, toluene, xylene and chlorobenzene; ethers such as diethyl ether, dibutyl ether, tetrahydrofuran, 1,4-dioxane, dimethoxyethane and diethylene glycol dimethyl ether; esters such as methyl acetate, ethyl acetate, butyl acetate and ethyl propionate; ketones such as acetone, methyl ethyl ketone, methyl isobutyl ketone and cyclohexanone; hydrocarbons such as hexane, heptane, octane and nonane; halogens such as dichloromethane, chloroform and 1,2-dichloroethane; hydrocarbons; organic acids such as formic acid, acetic acid and propionic acid; polar solvents such as N,N-dimethylformamide, N,N-dimethylacetamide and N-methylpyrrolidone; water; and mixtures of these solvents. The selected solvent is used for preparing a solution.

A method for coating the prepared solution on a base material is not particularly limited, and a known wet process such as a casting method and a spin coating method may be appropriately selected and used.

The solution may be dried in air or in a reduced pressure atmosphere, and after being substantially dried in air, it may be further dried in reduced pressure atmosphere.

Another method of the invention is a method of producing an amorphous triboluminescent film, and comprises spreading a solid mixture of a luminophore and a polymer into a film.

The solid mixture here may be free from a solvent. Preferably, the solid mixture is a solid fluid mixture. Examples of the mixture include paints, pastes and slurries. In this another method, the solid mixture can be spread by, for example, printing, painting, soaking, and grinding like plastic colorants method.

For descriptions of the amorphous triboluminescent film, the luminophore, the polymer, and ratio of the amount of the luminophore to the polymer, the corresponding descriptions in the descriptions for the amorphous triboluminescent film above may be referenced.

### Method for Producing Amorphous Triboluminescent Material

The method of the invention is a method for producing an amorphous triboluminescent material comprises:

impregnating a polymer film containing an amorphous polymer with a luminophore.

For descriptions for the amorphous polymer and the luminophore, the corresponding descriptions for the amorphous triboluminescent material above may be referenced.

Examples of the method of impregnating a polymer film with a luminophore include a method of immersing the polymer film in the liquid material containing a luminophore, and a method of supplying a liquid material containing the luminophore on the polymer film. The liquid material used in the impregnation may contain a solvent, a resin, and other known additives in addition to the luminophore. The liquid material including the luminophore may be applied on the polymer film using, for example, a writing instrument. As a result, it is possible to generate a light-emitting region having a planar shape such as a painting and a character. The writing instrument may be any one capable of supplying a liquid material containing the luminophore on the polymer film, and examples thereof include a fluorescent marker, a fluorescent fountain pen, and a writing brush.

### Mechanoresponsive Sensor, Fiber, Film and Dye

The mechanoresponsive sensor, fiber, film and dye of the invention comprises the amorphous triboluminescent material of the invention. The fiber, film and dye may be used as a sensor or a glowing product.

For descriptions for the amorphous triboluminescent material of the invention, the descriptions for the amorphous triboluminescent material above may be referenced.

When the sensor of the invention receives a mechanical stimulus or mechanical damage, the material contained in the sensor emits light in response to the stimulus. Therefore, by observing the light emission or the change in the light emission color, it is possible to easily detect the mechanical stimulus or the mechanical damage received by the sensor. The material contained in the sensor may be in the form of fibers, particles, pastes or films.

The sensor of the invention may have a sensitive unit containing the material of the invention and a light receiving unit that detects light generated in the sensitive unit and converts it into an analog voltage or a digital signal.

### EXAMPLE 1

Herein we developed a general approach to preparation of triboluminescent polymer films blended with a wide range of luminophores including biocompatible molecules. Wide range of polymer matrices can also be used. Light can be generated in these materials in response to rubbing, even in the absence of direct contact with the polymer (through the layer of another material). The response can be seen either under inert gas atmosphere or even under dry air and it does not require fracture or mechanical damage of the luminescent material. The preparation of the polymer films involves simple physical blending of the polymer with a luminophore and does not require covalent attachment.

To demonstrate utility of this method, we used nine representative luminophores that show fluorescence or phosphorescence: pyrene (Py), 9,10-diphenylanthracene (DPA), tetraphenylethene (TPE), 2,3,6,7-Tetrahydro-9-(trifluoromethyl)-1H,5H,11H-[1]benzopyrano[6,7,8-ij]quinolizin-11-one (Coumarin 153), Vitamin B₂ butyrate (VB₂-B), (4,5-bis(diphenylphosphino)-9,9-dimethylxanthene)(2,9-dimethyl-1,10-phenanthroline) copper(I) hexafluorophosphate (Cu(dmp)Xantp), fac-tris(2-phenylpyridinato-C²,N)iridium(III) (Ir(ppy)₃), fac-Tris(1,10-phenanthroline)-ruthenium(II) bis(hexafluorophosphate) (Ru(phen)₃),

Tris(acetylacetonato)mono(1,10-phenanthroline)europium(III) (Eu(acac)₃(phen)) (Scheme 1). Their derivatives are widely used in functional materials, organic light emitting diode (OLED), probes, and photo-redox catalysis. Among them, Py was investigated and reported in the literature to show no TL in crystal by grinding.

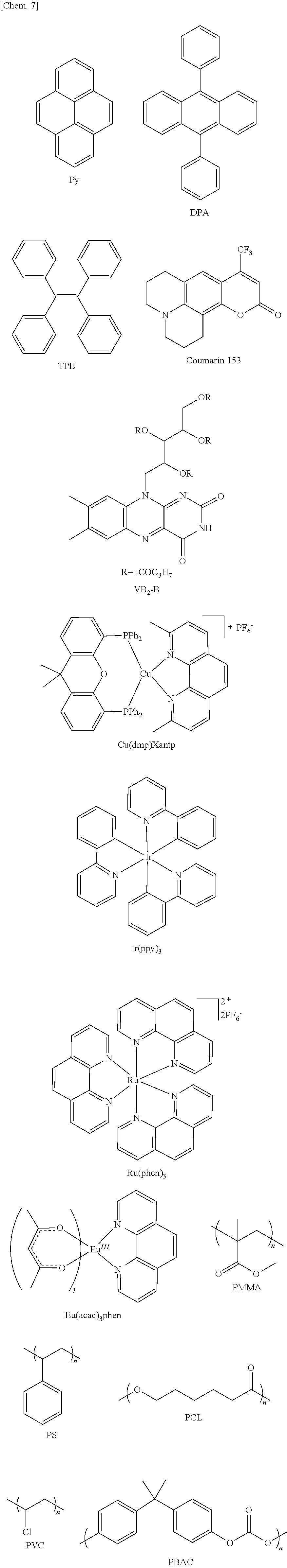

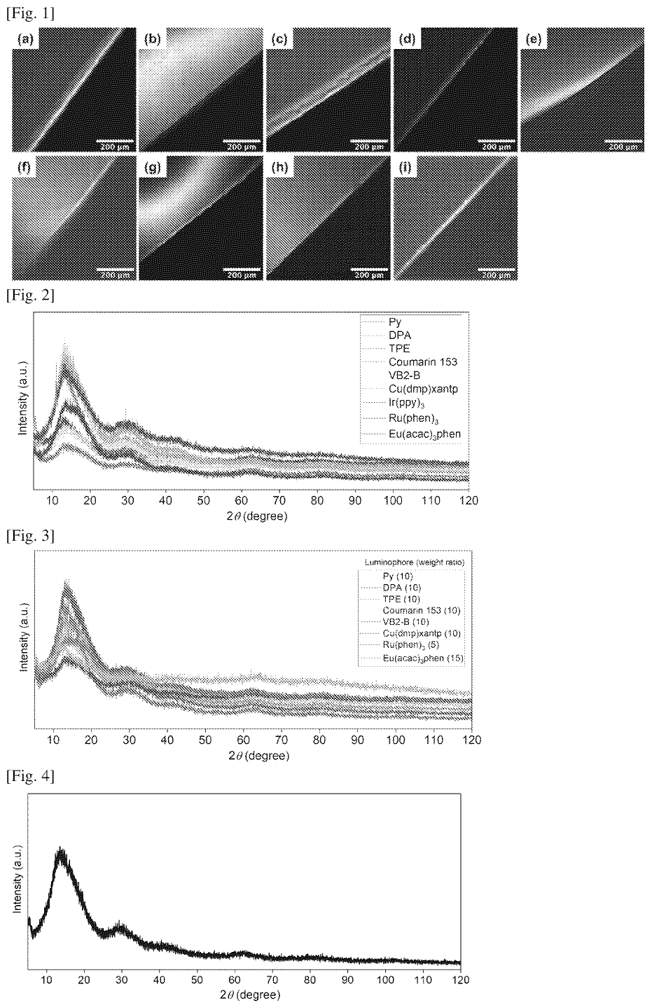

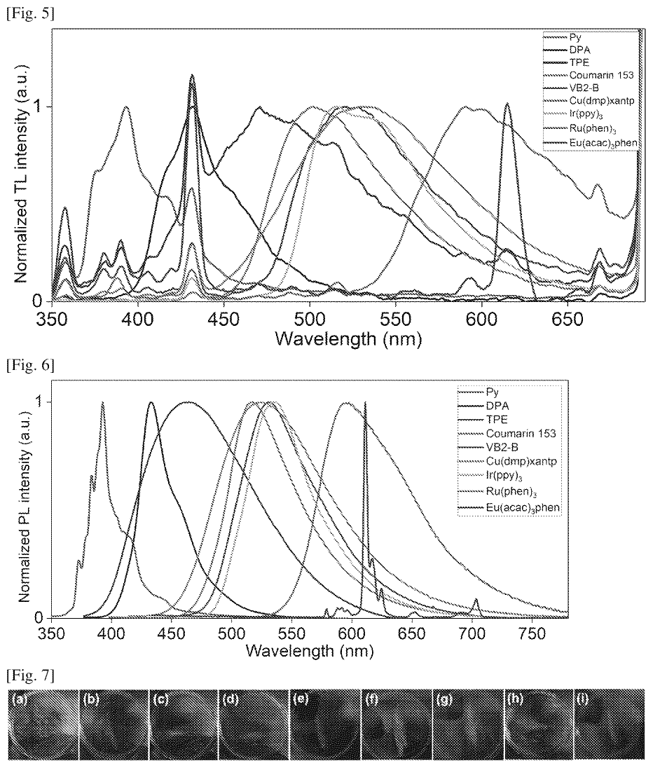

Amorphous blended polymer films were prepared using the luminophores and polymethylmethacrylate (PMMA) by simply dissolving the powder of luminophore (1-10 wt %) and PMMA in dichloromethane, followed by casting on glass and dried under vacuum. PXRD and emission microscopy imaging of the films confirmed absence of crystal and microcrystalline phase (FIGS. 1, 2, 3). The TL spectra of those luminophores in PMMA were measured by rubbing the surface with a glass tube containing a fiber optic probe inside a tube. The representative TL spectra under Ar gas are shown in FIG. 5. The TL spectra closely resemble photoluminescence (PL) spectra of the corresponding luminophores in PMMA films (FIG. 6). Emission maxima of PL and TL in PMMA are summarized in Table 1.

TABLE 1
PL and TL property of luminophores in PMMA film (1 wt %).

| | In PMMA film^{a} | | |
|---|---|---|---|
| | | λₘₐₓ | λₘₐₓ |
| Luminophore | PLQY | (PL) | (TL) |
| Py | 0.58 | 393 | 393 |
| DPA | 0.88 | 433 | 432 |
| TPE | 0.35 | 464 | 471 |
| Coumarin 153 | 0.59 | 516 | 508 |
| VB₂-B | 0.24 | 530 | 521 |
| Cu(dmp)(Xantp) | 0.60 | 523 | 535 |
| Ir(ppy)₃ | 0.74 | 535 | 534 |
| Ru(phen)₃ | 0.17 | 598 | 595 |
| Eu(acac)₃(phen) | 0.07 | 611 | 613 |

^{a}PL properties were measured under N₂ flow. TL were measured under Ar atmosphere.

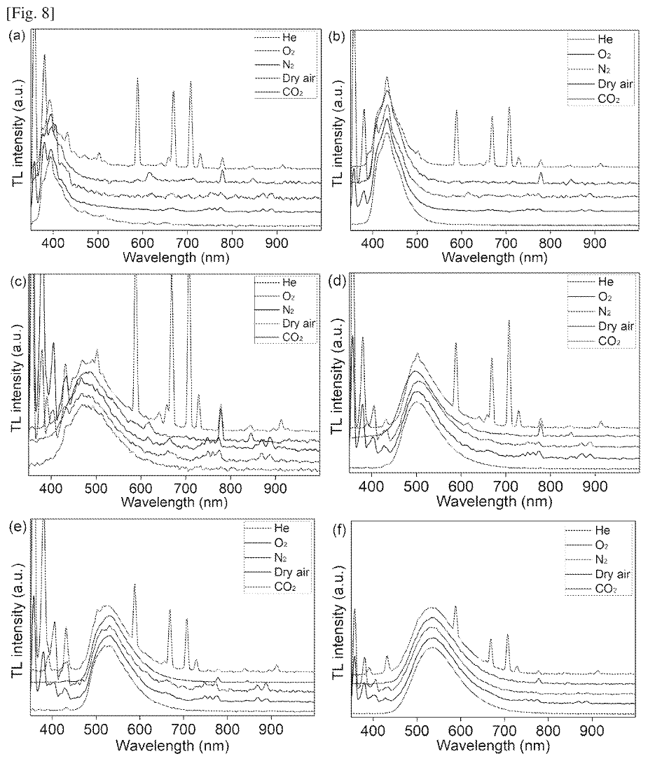

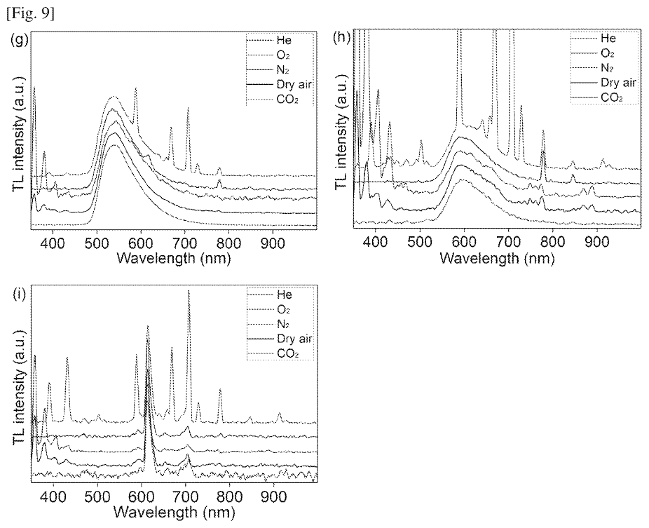

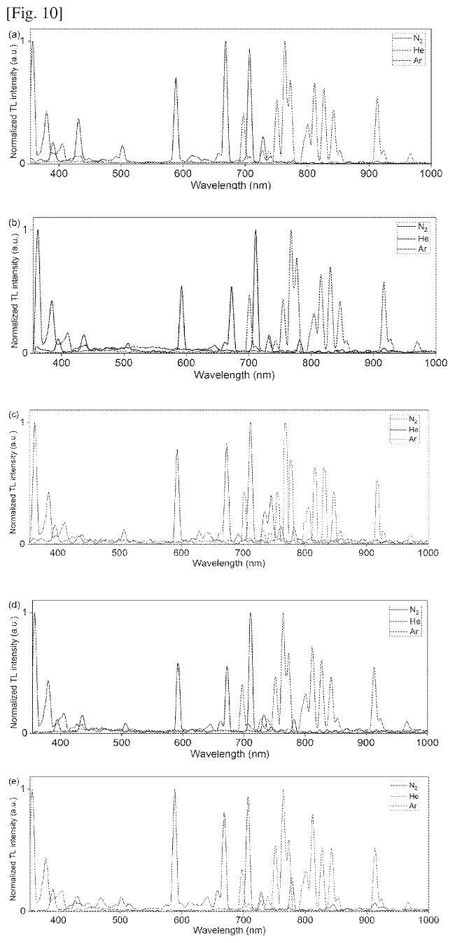

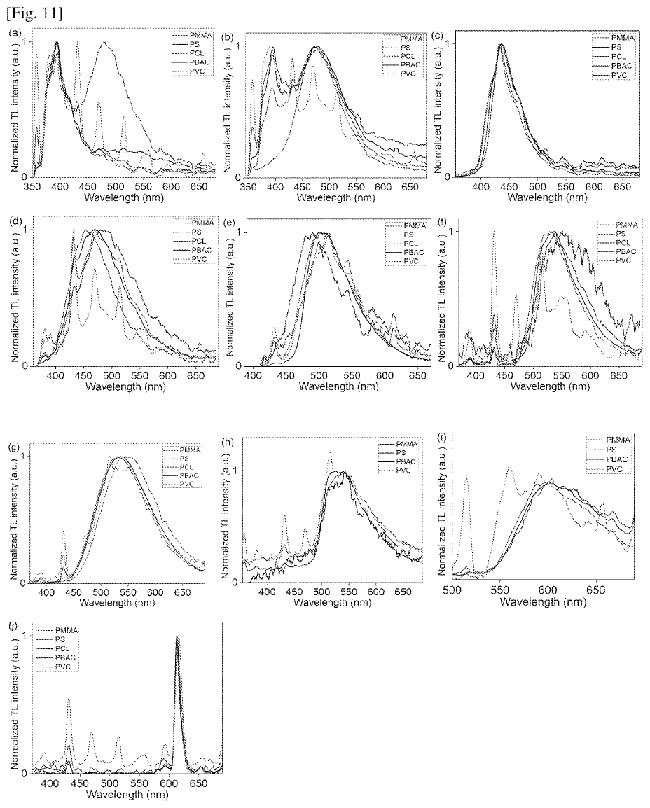

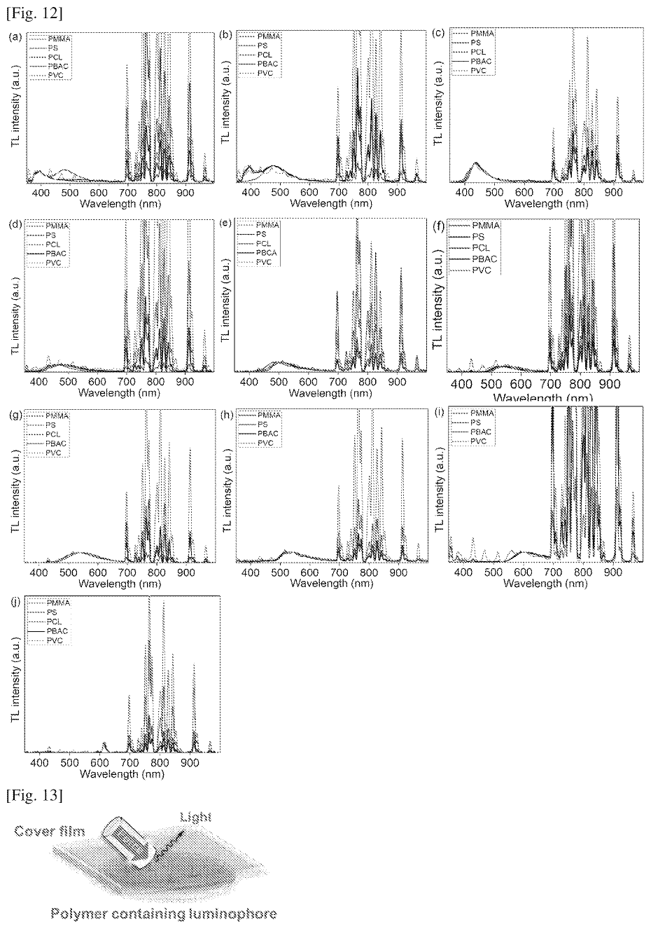

Full range TL spectra show emission corresponding to argon gas discharge in near IR region (FIG. 12). Images of TL of PMMA films with 10 wt % of luminophores under Ar are shown in FIG. 7. Because of poor miscibility, uniform distribution of several metal-based luminophores, Ru(phen)₃ and Ir(ppy)₃, could not be achieved in PMMA films with 10 wt %. TL spectra of luminophores blended in PMMA films in various gases including nitrogen, oxygen, helium, and dry air show TL spectrum containing peaks of corresponding luminophores as well as gas discharge emission lines (FIGS. 8,9). In the absence of luminophores, PMMA films also show the corresponding gas discharge emission line, although no visible light emission discernible by naked eye is observed (FIG. 10). TL emission of PMMA films containing Cu(dmp)Xantp, Ir(ppy)₃, Ru(phen)₃ is also observed under pure O₂ gas by spectroscopic measurement.

### EXAMPLE 2

Next, we confirmed that TL is also observed when various polymer matrices were blended with the same set of luminophores including: polystyrene (PS), poly(ε-caprolactone) (PCL), poly(bisphenol A)carbonate (PBAC), poly(vinyl chloride) (PVC). TL spectra of the selection of nine luminophores in these polymers is shown in FIG. 12. To the best of our knowledge, observation of TL from biocompatible materials such a VB2-B and PCL is unprecedented.

### EXAMPLE 3

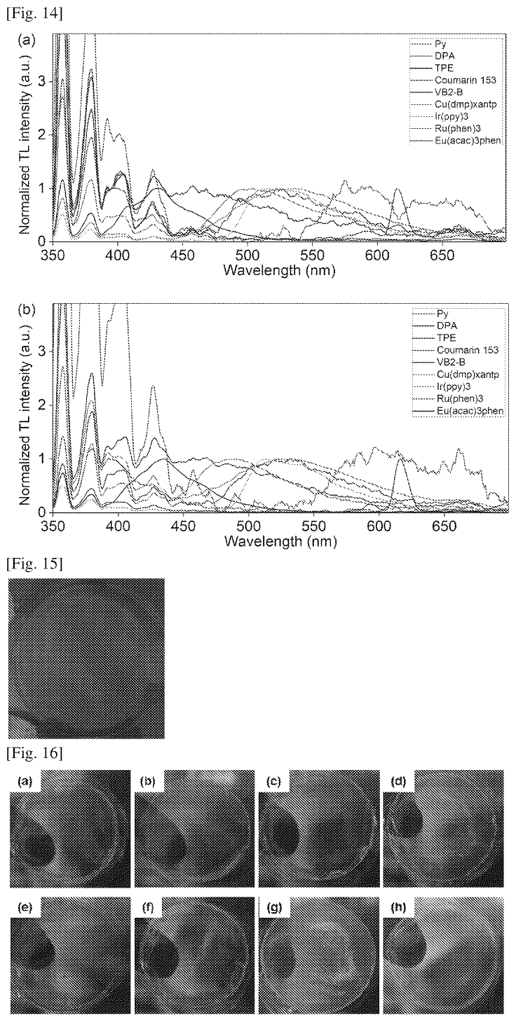

We next confirmed that light emission is observed even in the absence of direct contact through the layer of another film not containing a luminophore or other additives, as illustrated in FIG. 13. To demonstrate it, PMMA or PS films containing a luminophore (1 wt %) were physically covered with a PVC polymer film not containing a luminophore. Then the surface of the PVC upper layer was rubbed with glass rod under dry air. The spectra are shown in FIG. 14. This is the first demonstration that TL of luminophores blended in polymers generated in the absence of direct friction by another material, which is generated mechanical stimuli through the layer of another inert, additive-free polymer. Rubbing the surface of PVC cover film using poly(dimethyl siloxane) (PDMS) rubber rod or Latex rubber instead of glass rod showed far stronger TL, which produces visible light emission even under dry air. The images of TL of Ir(ppy)₃ (2 wt %) blended in PS films generated by rubbing PVC cover with silicone rubber in dark room under dry air is shown in FIG. 15. It was found that the TL intensity increases under argon atmosphere, which is probably due to lower dielectric strength of argon gas. The images of brighter TL of 1 wt % of luminophores blended in PS produced by gently stroking the surface of PVC cover film in dimmed room light are shown in FIG. 16. This TL was also observed by replacing the cover film of PVC with other polymer films including polyethylene terephthalate (PET) or polypropylene (PP) under argon atmosphere.

In summary, we have shown that triboluminescent polymer films can be obtained by simple physical blending of a wide range of polymer matrices with commonly available photoluminescent compounds. Rubbing polymer films directly or through a layer of another material produces visible light emission discernible even by naked eye, by spectroscopic methods or imaging methods. The emission can be seen under inert gas atmosphere or under dry air. Biocompatible luminophores such as VB2-B can also be utilized under these conditions.

### EXAMPLE 4

In this example, triboluminescence of luminophore in PBAC film was investigated under humid air.

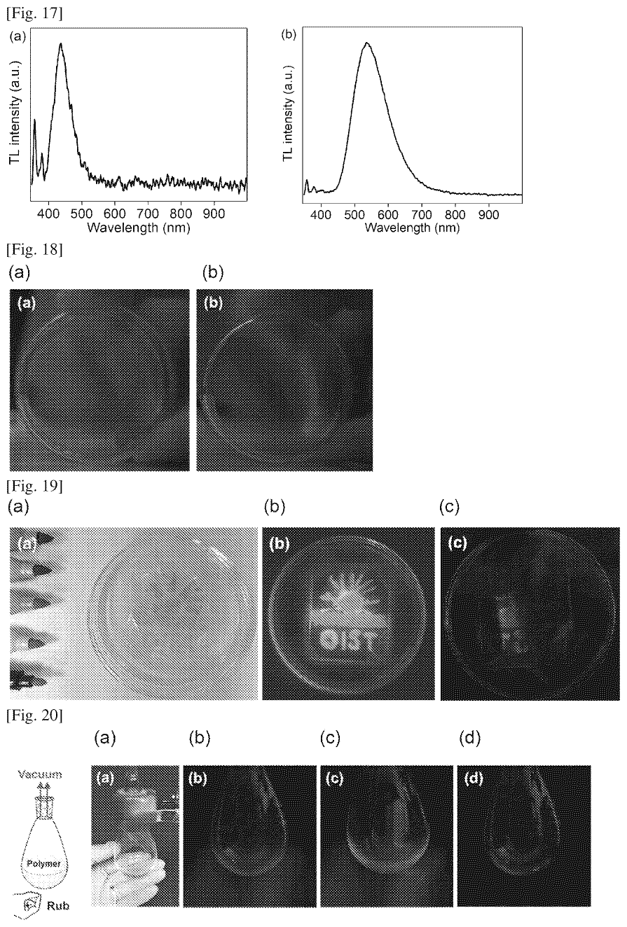

Each surface of PBAC films containing 3 wt % of DPA or Cu(dmp)Xantp was rubbed by a glass tube containing an optic fiber probe under humid air at 23° C. and a relative humidity of 34%, and the TL spectra of the PBAC films was measured. The TL spectrum of the PBAC containing DPA is shown in FIG. 17(a), and the TL spectrum of the PBAC film containing Cu(dmp)Xantp is shown in FIG. 17(b).

PBAC films containing 10 wt % of DPA or Cu(dmp)Xantp were placed on each glass petri dish, and each surface of the PBAC films was rubbed 20 times by a silicon rubber rod hold by fingers under humid air at 24° C. and a relative humidity of 40%, and the TL image of the PBAC films was photographed at an exposure time of 5 seconds. The photograph of TL of the PBAC film containing DPA is shown in FIG. 18(a), and the photograph of TL of the PBAC film containing Cu(dmp)Xantp is shown in FIG. 18(b).

As shown in FIG. 17 to 18, triboluminescence of luminophore in PBAC film was observed also under humid air.

### EXAMPLE 5

In this example, triboluminescence of polymer film impregnated with luminophore was investigated. The impregnation was performed by drawing an image on the surface of the polymer film with a fluorescent marker.

First, a painting was drawn on PS film with permanent fluorescent markers, and the PS film was placed on a glass petri dish and fixed by an adhesive tape. The photograph of the painting taken under normal indoor illumination is shown in FIG. 19(a), and the photograph of the painting under UV irradiation is shown in FIG. 19(b). Subsequently, the PS film was covered with a PVC cover film, and TL of the painting was generated by rubbing the surface of the PVC cover film by 20 times with a silicon rubber rod hold by fingers in a glove box under a relative humidity of 0%. The TL image of the painting was photographed at an exposure time of 5 seconds. The photograph of TL of the painting is shown in FIG. 19(c).

As shown in FIG. 19(c), all color components in the fluorescent marker generated emission. Thus, triboluminescence was observed in the painting drawn with a common fluorescent marker, confirming that the invention is practical.

### EXAMPLE 6

In this example, triboluminescence of luminophore in polymer film was investigated under vacuum.

PMMA films containing 10 wt % of DPA or Cu(dmp)Xantp were placed in cach round-bottom glass flask, and the insides of the flasks were degassed to create a vacuum. Each bottom of the flasks was rubbed 20 times with a latex rubber glove to generate TL under humid air, and TL of the PMMA films was photographed at an exposure time of 5 seconds. The photograph of the round-bottom glass flask of the PMMA film before rubbing is shown in FIG. 20(a), the photograph of TL of the PMMA film containing DPA is shown in FIG. 20(b), the photograph of TL of the PMMA film containing Cu(dmp)Xantp is shown in FIG. 20(c), and the photograph of the flask in a dark without rubbing is shown in FIG. 20(d).

As shown in FIGS. 20(b) and (c), triboluminescence of luminophore in polymer film was observed even under vacuum.

### REFERENCES

[1] aJ.-C. G. Bunzli, K.-L. Wong, Journal of Rare Earths 2018, 36, 1-41; bP. Jha, B. P. Chandra, Luminescence 2014, 29, 977-993; cS. Mukherjee, P. Thilagar, Angewandte Chemie International Edition 2019, 58, 7922-7932; dI. Sage, G. Bourhill, Journal of Materials Chemistry 2001, 11, 231-245; cE. Ubba, Y. Tao, Z. Yang, J. Zhao, L. Wang, Z. Chi, Chemistry-An Asian Journal 2018, 13, 3106-3121; fY. Xie, Z. Li, Chem 2018, 4, 943-971; gY. Zhuang, R.-J. Xie, Advanced Materials, 2021, 2005925.

[2] aR. S. Fontenot, W. A. Hollerman, K. N. Bhat, M. D. Aggarwal, B. G. Penn, Polymer Journal 2014, 46, 111-116; bT. M. George, M. J. Sajan, N. Gopakumar, M. L. P. Reddy, Journal of Photochemistry and Photobiology A: Chemistry 2016, 317, 88-99; cA. Incel, M. Emirdag-Eanes, C. D. McMillen, M. M. Demir, ACS Applied Materials & Interfaces 2017, 9, 6488-6496; dN. Takada, J.-i. Sugiyama, R. Katoh, N. Minami, S. Hieda, Synthetic Metals 1997, 91, 351-354.

[3] K. Nakayama, R. A. Nevshupa, Journal of Tribology 2003, 125, 780-787.

[4] A. Incel, C. Varlikli, C. D. McMillen, M. M. Demir, The Journal of Physical Chemistry C 2017, 121, 11709-11716.

[5] A. Karimata, P. H. Patil, R. R. Fayzullin, E. Khaskin, S. Lapointe, J. R. Khusnutdinova, Chemical Science 2020, 11, 10814-10820.

### INDUSTRIAL APPLICABILITY

According to the invention, it is possible to realize the triboluminescent material that generates emission of light in response to mechanical stimulus without light irradiation of ultraviolet, infrared ray, as well as without applying electric current and voltage. According to the invention, it is also possible to realize the triboluminescent film and the mechanoresponsive sensor by using a wide range of luminophore. It is still also possible to realize the stimuli sensors that act as indicator of temperature, pH, mechanical damage, chemical, which is utilized by TL in polymers Therefore, the invention has high industrial applicability.

1. An amorphous triboluminescent material comprising a luminophore and a polymer.

2. The amorphous triboluminescent material according to claim 1, wherein the luminophore is free from Cu.

3. The amorphous triboluminescent material according to claim 1, wherein the luminophore is not attached to the polymer covalently.

4. The amorphous triboluminescent material according to claim 1, wherein the luminophore have-has a condensed polycyclic structure in which three or more rings are condensed.

5. The amorphous triboluminescent material according to claim 1, wherein at least one of the luminophore and the polymer is biocompatible.

6. The amorphous triboluminescent material according to claim 1, wherein the polymer is an amorphous polymer.

7. The amorphous triboluminescent material according to claim 1, wherein
the material comprises an amorphous triboluminescent layer containing the luminophore and the polymer, and a luminophore-free layer containing a polymer and not containing a luminophore, and
the polymer of the amorphous triboluminescent layer is an amorphous polymer.

8. The amorphous triboluminescent material according to claim 7, wherein the luminophore-free layer is laminated on the amorphous triboluminescent layer.

9. The amorphous triboluminescent material according to claim 7, wherein the polymer of the amorphous triboluminescent layer and the polymer of the luminophore-free layer are different kind of polymers.

10. The amorphous triboluminescent material according to claim 7, wherein the polymer of the luminophore-free layer is a crystalline polymer.

11. The amorphous triboluminescent material according to claim 7, wherein the amorphous triboluminescent layer is entirely covered with the luminophore-free layer.

12. The amorphous triboluminescent material according to claim 7, wherein a part of the amorphous triboluminescent layer is covered with the luminophore-free layer.

13-17. (canceled)

17. A mechanoresponsive sensor, fiber, film or dye comprising the amorphous triboluminescent material of claim 1.
